(19) United States
(12) Patent Application Publication
(10) Pub. No.: US 2023/0290189 A1
(43) Pub. Date: Sep. 14, 2023

(54) FLEXIBLE QUEUE PROVISIONING FOR PARTITIONED ACCELERATION DEVICE

(71) Applicant: XILINX, INC., San Jose, CA (US)

(72) Inventors: Yanran CHEN, San Jose, CA (US); Sagheer AHMAD, Cupertino, CA (US); Amitava MAJUMDAR, San Jose, CA (US); Pramod BHARDWAJ, San Jose, CA (US)

(21) Appl. No.: 17/691,896

(22) Filed: Mar. 10, 2022

(51) Int. Cl. G07C 5/00; G06F 11/10; H04W 4/48

(52) U.S. Cl. CPC G07C 5/008; G06F 11/1004; H04W 4/48

(57) ABSTRACT

Embodiments herein describe wrapping non-safety compliant hardware resources with error detection checking to satisfy a safety standard. Doing so permits non-safety compliant hardware to be used to perform one or more tasks in a system that, as a whole, satisfies a particular safety standard (e.g., one of the ASIL QM, A, B, C, and D grades).

### TECHNICAL FIELD

Examples of the present disclosure generally relate to wrapping non-safety compliant hardware resources with error detection checking to satisfy a safety standard.

### BACKGROUND

Safety critical industries, such as the automotive industry, often desire safe communication between control units and peripherals, for example, to enable automatic emergency break (AEB) systems. Automotive Safety integrity Level (ASIL) is a risk classification system set by the ISO 26262 standard. The lowest to highest safety requirements set by this standard are ASIL QM, A, B, C, and D. Designing an integrated circuit (IC) with sufficient safety mechanisms to be compliant with ASIL-D grade requires significant development costs.

Current approaches rely on using ASIL-compliant budding blocks to achieve safety protection and at the system/channel level, which adds to cost and complexity. That is, each component in the system is designed to be compliant with the desired ASIL grade (e.g., ASIL D). This prevents the use of other hardware resources to perform one or more tasks in the system if those resources are not ASIL compliant.

### SUMMARY

One example is an integrated circuit that includes first circuitry that is compliant with a safety standard, the first circuitry configured to generate an error detection code for a message to be transmitted by the IC to an external destination, second circuitry that is not compliant with the safety standard where the second circuitry performs a task using the message and the error detection code, and a transceiver configured to transmit the message and the error detection code to the external destination where the first circuitry, the second circuitry, and the transceiver are part of a communication channel that satisfies the safety standard.

One example described herein is a system that includes a first IC that includes a first processor that is compliant with a safety standard, wherein the first processor is configured to: receive a message to be transmitted by the IC to an external destination and generate an error detection code for a message. The first IC also includes a first cryptographic engine configured to encrypt the message and the error detection code and a first transceiver configured to transmit the encrypted message and the error detection code. The system also includes a second IC that includes a second transceiver configured to receive the encrypted message and the error detection code from the first IC, a second cryptographic engine configured to decrypt the encrypted message and the error detection code, and a second processor that is compliant with the safety standard where the second processor is configured to check whether the decrypted message has errors by using the decrypted error detection code. Moreover, at least one of the first cryptographic engine or the second cryptographic engine is not compliant with the safety standard.

One example described herein is a method that includes receiving a message to be transmitted from an IC to an external destination; generating, using first circuitry in the IC, an error detection code for the message, wherein the first circuitry is compliant with a safety standard; performing, using second circuitry in the IC, a task using the message and the error detection code, where the second circuitry is not compliant with the safety standard, and transmitting, after performing the task, the message and the error detection code to the external destination, where the first circuitry and the second circuitry are part of a communication channel that satisfies the safety standard.

### BRIEF DESCRIPTION OF DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1 is an IC with ASIL-compliant and non-ASIL compliant hardware, according to an example.

FIG. 2 is a communication system for an automotive application using ICs from FIG. 1, according to examples.

FIG. 3 is a flowchart for wrapping non-safety compliant hardware resources with error detection checking to satisfy a safety standard, according to an example.

FIG. 4 is a communication system of non-ASIL compliant cryptographic engines being wrapped by ASIL-compliant error code checking, according to one embodiment.

FIG. 5 illustrates an IC with ASIL and non-ASIL domains, according to one embodiment.

To facilitate understanding, identical reference numerals have been used, where possible, to designate identical elements that are common to the figures. It is contemplated that elements of one example may be beneficially incorporated in other examples.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the features or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

Embodiments herein describe wrapping non-safety compliant hardware resources with error detection checking to satisfy a safety standard. Doing so permits non-safety compliant hardware to be used to perform one or more tasks in a system that, as a whole, satisfies a particular safety standard (e.g., one of the ASIL A, B, C, and D grades). For example, a safety critical industry may want the communication between components and peripherals to be both safe (e.g., meet a certain ASIL grade) and secure (perform data encryption). In one embodiment, an integrated circuit (IC)) may include a cryptographic engine that is not ASIL certified. That is, the cryptographic engine may not have been proven or certified to ensure it has sufficient diagnostic coverage against failure mechanisms such as flipped bits or transistor breakdown.

Rather than designing a new cryptographic engine that is ASIL certified, the embodiments herein wrap the non-ASIL compliant hardware (e.g., the cryptographic engine) with error checking capability that is ASIL compliant. For example, before transmitting a message to a component or peripheral, the IC may first add an error detection code (e.g., a cyclic redundancy check (CRC) code) to the message. The message and the error detection code can then be encrypted by the non-ASIL compliant cryptographic engine to form an encrypted payload. This payload can then be received by another IC which decrypts the payload using its cryptographic engine (which can be ASIL-compliant or non-ASIL compliant) and uses error detection capability to evaluate the error detection code and ensure no errors were introduced by the non-ASIL compliant hardware (i.e., one or both of the cryptographic engines). In this manner, non-ASIL-compliant hardware can be used in an ASIL compliant communication system.

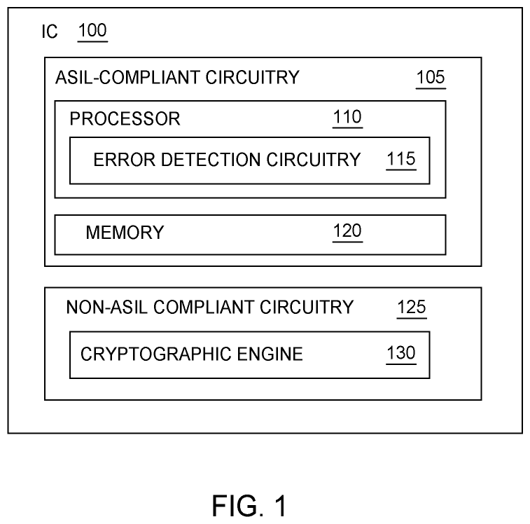

FIG. 1 is an IC 100 with ASIL-compliant and non-ASIL compliant hardware, according to an example. The IC 100 can be formed from one or more semiconductor materials. The IC 100 can be an application specific IC (ASIC), a field programmable gate array (FPGA), or a system on a chip (SoC). In one embodiment, the IC 100 contains only hardened, non-programmable circuitry. However, in another embodiment, the IC 100 contains both hardened circuitry and programmable logic.

The IC includes ASIL-compliant circuitry 105 and non-ASIL compliant circuitry 125. That is, the ASIL-compliant circuitry 105 has been designed, proven through tests or certified to ensure it meets a particular ASIL grade (e.g., ASIL-D), while the non-ASIL-compliant circuitry 125 does not. While the embodiments herein are described in the context of ASIL, they can apply to any safety related certification process or standard. For example, the embodiments can be used with the Safety Integrity Level (SIL) standard in non-automotive type safety applications, such as for industrial equipment.

The ASIL-compliant circuitry 105 includes a processor 110 and memory 120. The processor 110 can represent one or more hardened processors that each has one or more processing cores. These cores can be designed, proven through tests or certified to ensure they have high enough diagnostic coverage of single point faults or latent faults (e.g., random errors from bit Rips or breakdown errors from faulty circuitry).

The memory 120 can include volatile memory and non-volatile memory. Like the processor 110 (and its cores), the memory 120 can be designed, proven through tests or certified to ensure they have high enough diagnostic coverage of single point faults or latent faults. In this example, the memory 120 is disposed on the IC 100, but can also include memory that may be external to the IC 100.

The non-ASIL compliant circuitry 125 includes a cryptographic engine 130, which includes circuitry that is not ASIL compliant. That is, the IC 100 may not guarantee that the circuitry in the cryptographic engine 130 satisfies a particular ASIL grade. For example, the IC 100 may have been designed to be used in an automotive system that requires a particular ASIL grade. The IC designer saves both time and costs by implementing the cryptographic engine 130 as non-ASIL compliant circuitry 125. However, a customer may wish to add security to a communication channel by performing data encryption. The IC 100 includes the cryptographic engine 130, but it is not ASIL compliant. Instead of having to design a new IC that has an ASIL compliant cryptographic engine 130, the embodiments herein permit the non-ASIL compliant cryptographic engine 130 to be used in an automotive task that requires ASIL compliance.

The processor 110 provides error detection circuitry 115 that adds error detection codes (e.g., CRC codes) to messages being communicated in an ASIL compliant communication channel. While the embodiments herein illustrate dedicated circuitry 115 that adds the error detection codes, in other embodiments the error detection capability is provided using software executing on the processor 110. The cryptographic engine 130 can then be used to encrypt transmitted messages (and decrypt received packages) even though it is not ASIL compliant. The error detection codes can be used to catch any errors that are introduced from using the cryptographic engine 130, thereby ensuring the communication channel as a whole satisfies the ASIL grade. Put differently, the non-ASIL-compliant cryptographic engine 130 is wrapped around by the ASIL-compliant circuitry 105 so that the communication channel as a whole is ASIL compliant even though some parts of the channel (e.g., the encryption/decryption engines) are not ASIL compliant. This is discussed in more detail in the figures that follow.

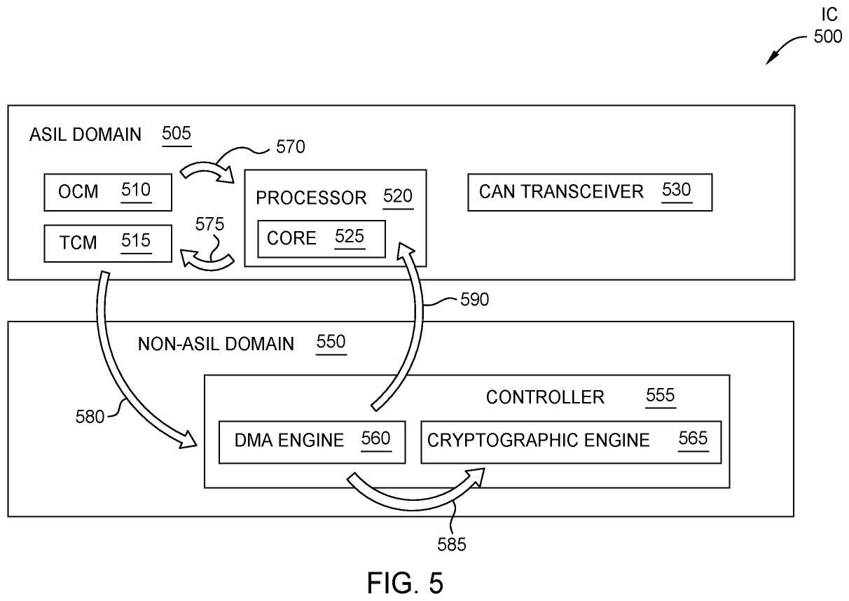

While FIG. 1 illustrates wrapping the cryptographic engine 130 in ASIL-compliant circuitry 105, the embodiments herein are not limited to using non-ASIL-compliant cryptographic engines 130. Other types of non-ASIL-compliant hardware can be wrapped by ASIL-compliant circuitry 105 to make the communication channel ASIL compliant. For example, DMA reads/writes can also be performed by non-ASIL-compliant hardware, which is described in FIG. 5 below. Thus, when designing a new IC, the system designer can identify components that can be wrapped by ASIL-compliant hardware, and thus, decide not to perform the time intensive process to design and test these components to be ASIL-compliant. This can reduce the overall cost of the IC without reducing safety.

While FIG. 1 illustrates that the cryptographic engine 130 is non-ASIL compliant, in other embodiments, the cryptographic engine 130 may be ASIL compliant, but at a lower grade. For example, the cryptographic engine 130 may be ASIL-B while the processor 110 and memory 120 are ASIL-D. If the customer decides to use the IC 100 in an application that requires ASIL-D, the cryptographic engine 130 would not qualify. However, using the embodiments herein, a lower-grade ASIL component can be used in a higher-grade ASIL task. That is, the ASIL-B cryptographic engine would be wrapped by the ASIL-D hardware in order for the task to meet the ASIL-D requirements. Thus, the embodiments herein can be used to wrap non-ASIL compliant hardware (or lower ASIL compliant hardware) with ASIL compliant hardware that has the desired ASIL grade of the particular automotive task.

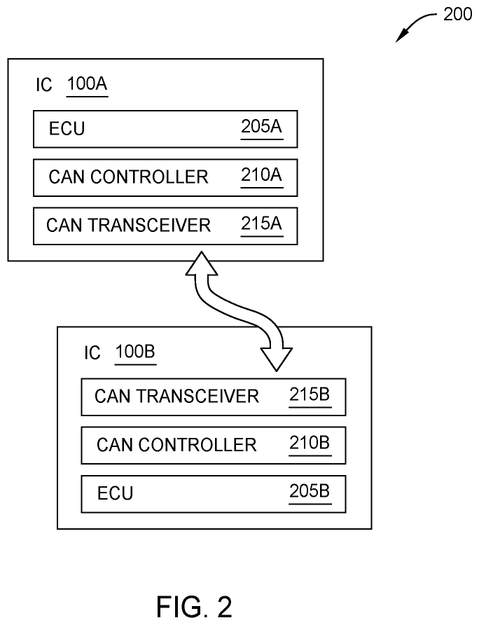

FIG. 2 is a communication system 200 for an automotive application using ICs from FIG. 1, according to examples. In this example, the communication system 200 includes a first IC 100A and a second IC 1008 that each has an electronic control unit (ECU) 205, a controller area network (CAN) controller 210, and a CAN transceiver 215, which can include a protocol-level controller. The ECUs 205 can control different systems in an automobile such as the engine, suspension, airbag, brakes, acceleration, and the like, Often, control of these systems requires the ECUs 205 to communicate with each other and other systems in the automobile as shown by FIG. 2. For example, the ICs 100 may use a bus (not shown) to communicatively couple the various systems.

The CAN controllers 210 can use a multi-master CAN protocol for real-time control of the ECUs 205. In one embodiment, the CAN controllers 210 can use the CAN flexible data rate (FD) of the CAN protocol to communicate. While FIG. 2 illustrates using the CAN protocol, the embodiments herein are not limited to such. Other communication protocols can be used to communicate between the ICs 100 such as Ethernet.

The CAN transceivers 215 include digital and analog components (e.g., analog front ends) for transmitting messages (e.g., data packets) between the ICs 100. These messages can include instructions, measurements, requests for information, and the like. The ECUs 205, the CAN controllers 210, and the CAN transceivers 215 can be ASIL compliant such that end-to-end protection from hardware errors can be achieved. However, as discussed above, some of the components in the CAN controllers 210 and the CAN transceivers 215 may not be ASIL compliant. For example, the CAN controllers 210 or the CAN transceivers 215 can include non-ASIL compliant encryption and decryption engines (e.g., the cryptographic engine 130 in FIG. 1) that perform data encryption on the messages being exchanged by the ICs 100. Thus, FIG. 2 illustrates that the ICs 100 can include non-ASIL compliant components but still achieve an ASIL compliant communication channel between ICs 100 (and between ECUs 205).

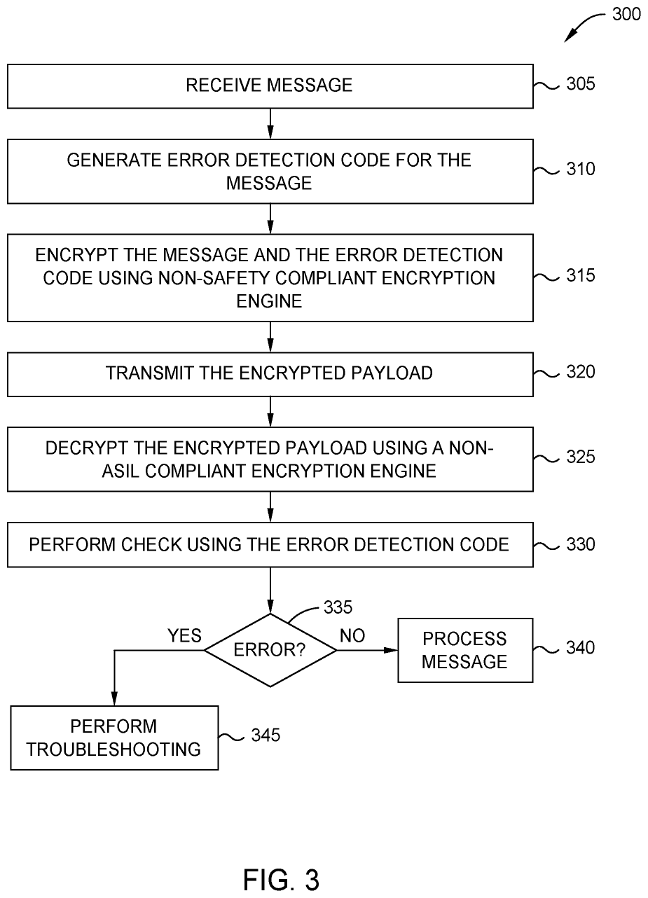

FIG. 3 is a flowchart of a method 300 for wrapping non-safety compliant hardware resources with error detection checking to satisfy a safety standard, according to an example. At block 305, error detection circuitry (e.g., the error detection circuitry 115 in FIG. 1) or software executing on the processor receives a message intended to be sent on a communication channel that is compliant with a safety standard such as ASIL, SIL, or some other safety standard or certification. For example, the communication channel may satisfy a particular ASIL grade, such as ASIL-D.

In one embodiment, the error detection function is performed on a portion of the IC that is compliant with the safety standard. That is, the error detection circuitry may be a piece of dedicated ASIL-compliant hardware. In one example, the error detection function may be performed as a software function on a general purpose processor.

In general, the method 300 can be used for any communication channel where that channel satisfies a particular safety standard. In most safety critical applications, the individual components in the communication channel satisfy the same safety standard. However, in the method 300, there is at least one component in the communication channel that does not. The error detection circuitry or software can be used to insulate or wrap around the non-safety compliant hardware so any errors generated by the non-safety compliant hardware are detected in order to satisfy the safety standard.

At block 310, the error detection circuitry or software generates an error detection code for the message. In one embodiment, the error detection code is generated based on the data (e.g., ones and zeros) in the message. One common error detection code is CRC which generates a value for a CRC code (e.g., a check value) using the information in the message such as the remainder of a polynomial division of the contents. However, the embodiments herein are not limited to any particular type of error detection technique.

In one embodiment, the number of bits used for the error detection code may vary depending on the desired level of the safety standard. The greater number of bits may enable the error detection technique to better detect errors in the message. For example, the error detection circuitry or software may use fewer bits in the error detection code when making sure the communication channel is compliant with ASIL-C than when ensuring the communication channel is compliant with ASIL-D which has a smaller tolerance for errors. Thus, the size and accuracy of the error detection code can vary depending on the particular level or grade of the safety standard. While detecting all errors using the error detection code is desired, it can be balanced with the added overhead introduced by appending the error detection codes to the message.

At block 315, the cryptographic engine (e.g., the cryptographic engine 130 in FIG. 1) encrypts the message and the error detection code. In this example, the cryptographic engine is non-safety-compliant cryptographic engine. For example, the cryptographic engine has not been certified to meet the particular level or grade of ASIL or SIL that is required for the communication channel. Nonetheless, as described below, the error detection code can be used to ensure the cryptographic engine did not introduce errors into the message. As such, the communication channel provides end-to-end protection that satisfies the desired level or grade of the safety standard.

The cryptographic engine can use any suitable cryptographic technique to generate an encrypted payload by encrypting the message and the error detection code. The message and the error detection code can be encrypted together or separately to form the encrypted payload.

At block 320, the IC transmits the encrypted payload to another IC. The IC that transmits the encrypted payload (i.e., the transmitting IC) can be the same IC that has the error detection circuitry and the cryptographic engine that performed blocks 305-315. Thus, the transmitting IC can have circuitry that is compliant with the safety protocol as well as circuitry that is not compliant with the safety protocol.

In one embodiment, the transmitting IC uses a suitable communication protocol such as the CAN protocol or Ethernet to transmit the encrypted payload to the receiving IC. In one embodiment, the payload is transmitted in one or more packets to the receiving IC.

At block 325, a cryptographic engine on the receiving IC decrypts the encrypted payload. Like the cryptographic engine on the transmitting IC, the cryptographic engine on the receiving IC can be non-compliant with the safety standard. That is, the cryptographic engine may not be certified for a particular grade or level of the safety standard. Nonetheless, the error detection code appended to the message at block 310 can be used to catch errors that may have occurred in either of the cryptographic engines in the ICs.

In one embodiment, however, one of the cryptographic engines may be compliant with the safety protocol. That is, the cryptographic engine that encrypted the message and the error detection code at block 315 may instead be compliant with the safety protocol while the cryptographic engine that decrypts the encrypted payload at block 325 is not, or vice versus. The method 300 can be used so long as one component in the communication channel is not compliant with the safety protocol. This gives the system designer more flexibility. For example, some ICs may only have circuitry that is compliant with the safety protocol but other ICs do not. The ICs that are compliant can still be used with ICs that have one or more components that are not compliant. Thus, the method 300 can give the system designer the ability to mix and match between ICs that may have components that are not compliant with the desired level of the safety protocol.

In one embodiment, after decrypting the encrypted payload, the cryptographic engine on the receiving IC can reproduce the message and the error detection code. Assuming there are no errors, the message and error detection code generated at block 325 by decrypting the payload should be the same as the message and error detection code that were encrypted at block 315.

At block 330, the error detection circuitry or software in the receiving IC performs an error check using the error detection code. That is, the error detection circuitry or software can use the error detection code to determine whether an error was introduced in either the message or the error detection code when this data was being encrypted and decrypted by hardware that was not compliant with the safety protocol.

If the error detection circuitry or software detects there is no error at block 335 (e.g., the error detection code indicates the message has the correct data), the method 300 proceeds to block 340 where the message can be processed by downstream circuitry (e.g., an ECU or controller in the receiving IC).

If, however, the error detection circuitry or software detects an error, the method 300 proceeds to block 345 where the receiving IC performs troubleshooting. This can include requesting that the transmitting IC retransmit the message, sending an error to an operating system or primary controller, or changing the operational state of the system. For example, cosmic ray may have caused a bit to flip in either the message or the error detection code which causes the error detection circuitry or software to detect an error at block 335. The receiving IC can request that the transmitting IC resend the message, which is likely not going to have the same error (since bit flips are rare events). However, if the receiving IC continues to detect errors, there may be a problem with the underlying circuitry in the cryptographic engines (e.g., a faulty transistor). In that case, the receiving IC may alert a primary controller or operating system that there is a problem with the communication channel. The system may also enter into a safe state to prevent any unsafe operating conditions.

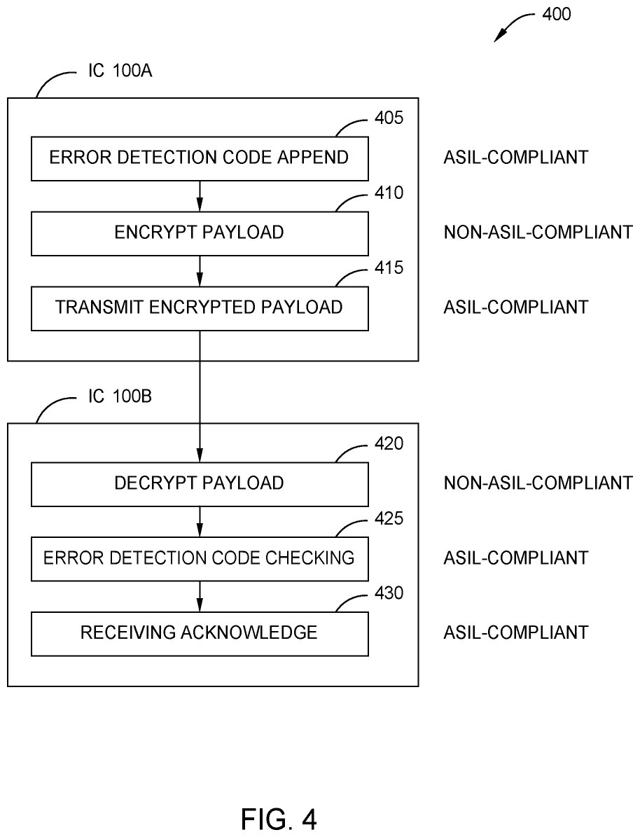

FIG. 4 is a communication system of non-ASIL compliant cryptographic engines being wrapped by ASIL-compliant error code checking, according to one embodiment. The system 400 includes blocks 405-430 in a flow that are illustrated as either being ASIL-compliant or non-ASIL compliant. Further, the blocks 405-430 are shown as being performed in one of two ICs. In this case, the IC 100A is a transmitting IC and the IC 100B is a receiving IC. But the communication channel in FIG. 4 can be bidirectional where the IC 100B transmits messages to the IC 100A, in which case the IC 1005 is the transmitting IC and the IC 100A is the receiving IC.

At block 405, the IC 100A appends error detection code to a message that is going to be sent to the IC 1005. In one embodiment, the message is generated by circuitry on the IC 100A. However, in another embodiment, the message is received by the IC 100A from another component in the system (e.g., a sensor) which is then being forwarded by the IC 100A to the IC 1005.

In this embodiment, the circuitry in the IC 100A that generates and appends the error detection code to the message is ASIL compliant. Thus, the circuitry that performs this task (e.g., the error detection circuitry or software) has been certified to satisfy the diagnostic coverage requirements of the desired ASIL grade.

At block 410, the IC 100A encrypts the payload. This block can be performed by a cryptographic engine using any suitable encryption technique. However, unlike block. 410, the circuitry that encrypts the payload is not ASIL compliant. In other words, the circuitry may not have been certified to have a diagnostic coverage of errors that satisfies the desired ASIL grade for the communication channel.

At block 410, the IC 100A transmits the encrypted payload to the IC 1006. The encrypted payload can include both the message and the error detection code, but in an encrypted state. The IC 100A can use any suitable communication protocol to transmit the encrypted payload to the IC 1008, such as CAN or Ethernet.

At block 420, the IC 1008 decrypts the payload. In this embodiment, block 420 is performed using circuitry in the IC 1006 that is not ASIL compliant. That is, like block 410, the circuitry may not have been designed or certified to have the diagnostic coverage of errors required by the desired ASIL grade. However, as discussed above, the non-ASIL compliant circuitry in the IC 100A and the IC 1006 can be wrapped or protected by the ASIL compliant circuitry that generates the error detection code.

Although the system 400 illustrates both ICs 100A and 1006 containing non-ASIL compliant circuitry for performing encryption and decryption, in other embodiments, one of block 410 or block 420 is performed by circuitry that is ASIL compliant. In that case, the error detection code can still be used to detect errors that occurred in the circuitry that is not ASIL compliant.

At block 425, the IC 1006 performs error checking to determine whether an error was introduced by the non-ASIL compliant circuitry in either the IC 100A and the IC 100B. In this manner, the non-ASIL compliant circuitry can be used to perform one or more tasks in an ASIL compliant communication channel. That is, the system 400 can provide end-to-end protection that satisfies the requirements of a particular ASIL grade while still using non-ASIL compliant circuitry in one or both of the ICs 100.

At block 430, downstream circuitry in the IC 1008 receives an acknowledge from the circuitry that performed block 425, indicating whether the message had an error. If not, the downstream circuitry is then free to process the message. If not, the IC 1008 can perform a troubleshooting actions, such as one of the actions discussed in the method 300.

FIG. 5 illustrates an IC 500 with ASIL and non-ASIL domains. The ASIL domain 505 of the IC 500 includes on-chip memory (OCM) 510, tightly coupled memory (TCM) 515, a processor 520, and a CAN transceiver 530. Because these components are in the ASIL domain 505, they have been designed and certified to achieve a desired ASIL grade. In contrast, the non-ASIL domain 550 includes a controller 555 which in turn includes a direct memory access (DMA) engine 560 and a cryptographic engine 565. These components have not been certified to achieve the desired ASIL grade. While the controller 555 is shown as being a separate processing element in the IC 500 from the processor 520, in other embodiments, the controller 555 may be part of the processor 520. For example, the processor 520 may have a first portion (e.g., the core 525) which is ASIL compliant but a second portion (e.g., the controller 555) which is not ASIL compliant.

Using the embodiments herein, the hardware components in the non-ASIL domain 550 can still be used to perform tasks in a safety critical communication channel by wrapping these hardware components by the hardware components in the ASIL domain 505. For example, the DMA engine 560 and the cryptographic engine 565 can be used to enable secure communication between different ICs. This communication may be a safety critical function where the communication channel has to satisfy the desired ASIL grade.

In one embodiment, a core 525 in the processor 520 retrieves a message from the OCM 510 or the TCM 515. This is shown by the arrow 570. For example, the message may have been generated by an ECU or using data from a sensor that is coupled to the IC 500. In any case, the IC 500 is tasked with transmitting the message to an external destination (e.g., another IC or component in the safety critical system).

The core 525 can then generate an error detection code for the message (e.g., a CRC check value). The core 525 can perform a similar process as described at block 310 in FIG. 3. The core 525 can then store the error detection code along with the message in the OCM 510 or the TCM 515. This is shown by the arrow 575.

The core 525 then instructs the DMA engine 560 to retrieve the message and the error detection code from the OCM 510 or the TCM 515. As shown by the arrow 580, the DMA engine 560 performs a DMA read to retrieve the message and the error detection code from the OCM 510 or the TCM 515.

The message and the error detection code are then transferred to the cryptographic engine 565 as shown by the arrow 585. The cryptographic engine 565 then uses a suitable cryptographic technique to encrypt this data, which was discussed at block 315 of FIG. 3.

After encrypting the data, the DMA engine 560 can perform a DMA write to transmit the encrypted message and error detection code (e.g., the encrypted payload) to the core 525. This is shown by the arrow 590, As such, the tasks performed by the non-ASIL compliant hardware—e.g., the DMA read and writes and data encryption—are performed at the behest of the ASIL compliant hardware—e.g., the core 525. Thus, the ASIL compliant hardware can be considered as wrapping around the non-ASIL compliant hardware where the error detection code can be used to detect any errors that may have been introduced into the message. That is, once the encrypted payload has been sent to another IC and has been decrypted, the ASIL compliant hardware in that IC can use the error detection code to ensure error coverage for the entire communication channel including the non-ASIL compliant hardware in the IC 500 satisfies the targeted ASIL standard.

The core 525 can then instruct the CAN transceiver 530 to transmit the encrypted message and error detection code to the other IC. This IC can use a non-ASIL compliant, or ASIL compliant, DMA engine and cryptographic engine to decrypt the data. An ASIL compliant core can then perform error checking before performing a task indicated by the message or forwarding the message to downstream circuitry in the IC. In this manner, multiple tasks can be performed by non-ASIL hardware, such as DMA reads/writes and encryption/decryption, in an ASIL compliant communication channel.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative Implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

What is claimed is:

1. An integrated circuit (IC), comprising:
first circuitry that is compliant with a safety standard, the first circuitry configured to generate an error detection code for a message to be transmitted by the IC to an external destination;
second circuitry that is not compliant with the safety standard, wherein the second circuitry performs a task using the message and the error detection code; and
a transceiver configured to transmit the message and the error detection code to the external destination, wherein the first circuitry, the second circuitry, and the transceiver are part of a communication channel that satisfies the safety standard.

2. The IC of claim 1, wherein the second circuitry comprises a cryptographic engine, where the task comprises the cryptographic engine encrypting the message and the error detection code.

3. The IC of claim 2, wherein the transceiver is configured to transmit the encrypted message and error detection code to the external destination.

4. The IC of claim 2, wherein the error detection code is configured to detect an error introduced in the message or the error detection code due to the cryptographic engine not being compliant with the safety standard.

5. The IC of claim 4, wherein the error detection code is a cyclic redundancy check (CRC) check value.

6. The IC of claim 1, wherein the safety standard is a Safety Integrity Level (SIL).

7. The IC of claim 1, wherein the safety standard is an Automotive Safety Integrity Level (ASIL).

8. A system, comprising:
a first IC comprising:
a first processor that is compliant with a safety standard, wherein the first processor is configured to:
receive a message to be transmitted by the IC to an external destination, and
generate an error detection code for a message;
a first cryptographic engine configured to encrypt the message and the error detection code, and
a first transceiver configured to transmit the encrypted message and the error detection code; and
a second IC comprising:
a second transceiver configured to receive the encrypted message and the error detection code from the first IC,
a second cryptographic engine configured to decrypt the encrypted message and the error detection code, and
a second processor that is compliant with the safety standard, wherein the second processor is configured to check whether the decrypted message has errors by using the decrypted error detection code,
wherein at least one of the first cryptographic engine or the second cryptographic engine is not compliant with the safety standard.

9. The system of claim 8, wherein both the first cryptographic engine and the second cryptographic engine are not compliant with the safety standard.

10. The system of claim 8, wherein the error detection code is configured to detect an error introduced in the message or the error detection code due to the first or second cryptographic engine not being compliant with the safety standard.

11. The system of claim 8, wherein the safety standard is a SIL.

12. The system of claim 11, wherein the safety standard is an ASIL.

13. The system of claim 12, wherein the first IC comprises an electronic control unit (ECU) configured to control an automotive system, wherein the message is generated by the ECU.

14. A method, comprising:
receiving a message to be transmitted from an IC to an external destination;
generating, using first circuitry in the IC, an error detection code for the message, wherein the first circuitry is compliant with a safety standard;
performing, using second circuitry in the IC, a task using the message and the error detection code, wherein the second circuitry is not compliant with the safety standard; and
transmitting, after performing the task, the message and the error detection code to the external destination, wherein the first circuitry and the second circuitry are part of a communication channel that satisfies the safety standard.

15. The method of claim 14, wherein performing the task comprises:
encrypting the message and the error detection code such that the message and the error detection code are transmitted to the external destination in an encrypted state.

16. The method of claim 15, wherein the error detection code is configured to detect an error introduced in the message or the error detection code due to encrypting the message and the error detection code using the second circuitry which is not compliant with the safety standard.

17. The method of claim 15, further comprising:
receiving the message and the error detection code at the external destination;
decrypting, using third circuitry in the external destination, the message and the error detection code; and
performing, using fourth circuitry in the external destination, an error check using the error detection code.

18. The method of claim 17, wherein the third circuitry is not compliant with the safety standard but the fourth circuitry is compliant with the safety standard.

19. The method of claim 17, wherein both the third circuitry and the fourth circuitry are compliant with the safety standard.

20. The method of claim 14, wherein the safety standard is a SIL.
